(19) United States
(12) Patent Application Publication
(10) Pub. No.: US 2015/0328678 A1
(43) Pub. Date: Nov. 19, 2015

(54) METHODS AND COMPOSITIONS FOR FORMATION OF CERAMIC ARTICLES

(71) Applicant: GENERAL ELECTRIC COMPANY, SCHENECTADY, NY (US)

(72) Inventors: Thomas Francis McNulty, Ballston Lake, NY (US); Michael Joseph O'Brien, Halfmoon, NY (US); John Thomas Leman, Schenectady, NY (US); Ayesha Maria Gonsalves, Schenectady, NY (US)

(73) Assignee: GENERAL ELECTRIC COMPANY, SCHENECTADY, NY (US)

(21) Appl. No.: 14/280,993

(22) Filed: May 19, 2014

(51) Int. Cl. B22C 1/00; C04B 35/14; C04B 38/00; B22C 9/02

(52) U.S. Cl. CPC B22C 1/00; B22C 9/02; C04B 35/14; C04B 38/0087; C04B 2235/483; C04B 2235/3427; C04B 2235/3418; C04B 2235/74

(57) ABSTRACT

Compositions and methods useful for forming ceramic articles, such as, for instance, cores and shells for investment casting, are provided. The composition comprises a liquid that comprises a siloxane species; a plurality of particles, comprising a ceramic material, disposed within the liquid; a catalyst material disposed within the liquid; and a pore-forming agent disposed within the liquid. The pore-forming agent comprises a silicon-bearing agent that is substantially inert with respect to the liquid, and has an average molecular weight less than about 1300 grams per mole. The method comprises disposing any of the compositions described above in a desired shape; curing the siloxane species, and volatilizing the pore-forming agent to form a porous green body.

### BACKGROUND

This disclosure generally relates to investment casting, and more particularly, relates to materials for use in forming the ceramic cores and shell molds employed in investment casting.

The manufacture of gas turbine components, such as turbine blades and nozzles, requires that the parts be manufactured with accurate dimensions having tight tolerances. Investment casting is a technique commonly employed for manufacturing these parts. The dimensional control of the casting is closely related to the dimensional control of a ceramic insert, known as the core, as well as the mold, also known as the shell. In this respect, it is important to be able to manufacture the core and shell to dimensional precision corresponding to the dimensions of the desired metal casting, e.g., turbine blade, nozzle, and the like.

In addition to requiring dimensional precision in the casting of the ceramic core, the production of various turbine components requires that the core not only be dimensionally precise but also be sufficiently strong to maintain its shape during the firing, wax encapsulation, shelling, and metal casting processes. In addition, the core must be sufficiently compliant to prevent mechanical rupture of the casting during cooling and solidification. Further, the core materials generally must be able to withstand temperatures commonly employed for casting of superalloys that are used to manufacture the turbine components, e.g., temperatures generally in excess of 1,000° C. Finally, the core must be easily removed following the metal-casting process. The investment casting industry typically uses silica or silica-based ceramics due to their superior leachability in the presence of strong bases.

Investment casting cores and shells can be made using low pressure injection molding techniques such as that described in U.S. Pat. No. 7,287,573. The process described therein generally includes dispersing a ceramic powder to form a slurry in a silicone fluid, wherein the silicone fluid includes silicone species having alkenyl and hydride functionalities. In some cases, the silicone species are first dissolved in a volatile solvent, (e.g., aliphatic and aromatic hydrocarbons that can be removed by heat treatment), which are then added to the ceramic powder to form a ceramic slurry and further processed. Once a stable suspension is formed, a metallic catalyst is added and the desired part is formed. Depending on the particular binder liquid and metallic catalyst employed, a heating step may then be applied to effect a catalyzed reaction among the siloxane species, thereby curing the formed suspension into a green body. The silicone species cross link in the mold, yielding a dispersion of ceramic particles in a rigid silicone-based polymeric matrix. The so-formed silicone polymeric matrix may be substantially decomposed to produce a silica char by further heating at a higher temperature.

The process described above provides improvements over previously developed processes for forming ceramic cores for investment casting. However, some opportunities for improvement still exist. For instance, the solvent-free approach may result in fairly dense material being formed in the green body; the lack of porosity may lead to size-dependent shrinkage that can lead to cracking during the firing step. This cracking can be particularly acute in cases where the feature scale (i.e. the size difference between small and large features on the core) is large. The use of a solvent in the process may at least partially address this problem, in that interconnected porosity may form in the core as a result of the solvent removal prior to the curing step. However, the inclusion of solvent in the process results in the emission of volatile organic compounds (VOCs) and, in some cases may create a need for the use of special liquid-permeable molds designed for solvent removal.

Accordingly, there remains a need in the art for improved ceramic slurries and related processes that provide cores and other ceramic bodies, such as those used in investment casting, having desirable physical and mechanical characteristics.

### BRIEF DESCRIPTION

Embodiments of the present invention are provided to meet this and other needs. One embodiment is a composition. The composition comprises a liquid that comprises a siloxane species; a plurality of particles, comprising a ceramic material, disposed within the liquid; a catalyst material disposed within the liquid; and a pore-forming agent disposed within the liquid. The pore-forming agent comprises a silicon-bearing agent that is substantially inert with respect to the liquid, and has an average molecular weight less than about 1300 grams per mole.

Another embodiment is a composition that includes a liquid comprising a siloxane species, the siloxane species comprising an alkenyl functional group and a hydride functional group; a plurality of particles, comprising a ceramic material, disposed within the liquid; a catalyst material comprising a metal, and disposed within the liquid; and a pore-forming agent disposed within the liquid. The pore-forming agent comprises decamethylcyclopentasiloxane and is present in the composition at a concentration of 5 volume percent to about 35 volume percent of the entire composition.

Another embodiment is a method, comprising disposing any of the compositions described above in a desired shape; curing the siloxane species, and volatilizing the pore-forming agent to form a porous green body.

### DETAILED DESCRIPTION

Embodiments of the present invention include compositions and methods for fabrication of porous ceramic bodies, such as cores, for use in investment casting and in other applications where a porous ceramic structure is advantageous. The compositions do not rely on VOC-emitting solvents to provide interconnected porosity, and in some cases may be entirely free of such solvents, thereby mitigating some of the shortcomings of previously described techniques as noted above.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

One embodiment of the present invention includes a composition that may be usefully employed in, for example, a process for making a porous ceramic body; such a process is exemplified, but not necessarily limited to, the techniques disclosed in the aforementioned U.S. Pat. No. 7,287,573, as well as in U.S. Pat. No. 7,413,001, U.S. Pat. No. 7,487,819, and U.S. Pat. No. 8,413,709, among others.

The composition is typically a slurry that includes ceramic powders dispersed within a silicon-bearing liquid; the liquid may also be referred to as a “binder” in the parlance of slurry techniques. In particular, the liquid includes a siloxane species, for instance, (a) one or more siloxane polymers—such as (but not limited to) the so-called “Room Temperature Vulcanizable,” (RTV) systems well known in the silicones art, including as an example RTV 615 (trade name of Momentive Performance Materials), as well as other such silicone formulations that contain polymeric inputs; (b) siloxane monomers; and/or (c) siloxane oligomers. The siloxane species may include alkenyl and hydride functionalities. The siloxane species used in the liquid is of a type referred to in the art as “curable” or “reactive,” meaning that under a given set of processing conditions, the species will undergo a cross-linking (“curing”) reaction; the process of curing is described in further detail, below.

The siloxane species having alkenyl functionalities that may be used as a binder liquid in the composition described herein are alkenyl siloxanes of the general formula (I):

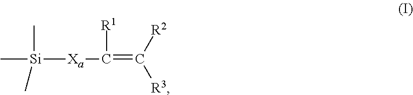

wherein R1, R2, and R3 each independently comprise hydrogen or a monovalent hydrocarbon, halocarbon, or halogenated hydrocarbon radical; X a divalent hydrocarbon radical; and a is a whole number having a value between 0 and 8, inclusive. The terms “monovalent hydrocarbon radical” and “divalent hydrocarbon radical” as used herein are intended to designate straight chain alkyl, branched alkyl, aryl, aralkyl, cycloalkyl, and bicycloalkyl radicals.

The siloxane species that include hydride functionalities are hydrosiloxanes having hydrogen directly bonded to one or more of the silicon atoms, and therefore contain a reactive Si—H functional group.

Exemplary alkenyl siloxanes useful in the present disclosure include polyfunctional olefinic substituted siloxanes of the following types:

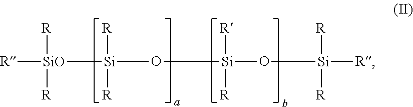

wherein R is a monovalent hydrocarbon, halocarbon, or halogenated hydrocarbon; and R′ is an alkenyl radical such as vinyl, or other terminal olefinic group such as allyl, 1-butenyl, and the like. R″ may include R or R′, a=0 to 200, inclusive, and b=1 to 80, inclusive, wherein a and b are selected to provide a fluid with maximum viscosity of about 1,000 centistokes, and such that the ratio of b/a allows for at least three reactive olefinic moieties per mole of siloxane of formula (II) above.

Suitable alkyl/alkenyl cyclosiloxanes are of formula (III):

[RR′SiO]x, (III)

wherein R and R′ are as previously defined, and x is an integer 3 to 18 inclusive.

Other suitable functional unsaturated siloxanes may be of the formula (IV):

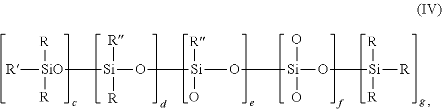

wherein R, R′, and R″ are as previously defined. In some embodiments, the ratio of the sum of (c+d+e+g)/f is >2.

Exemplary unsaturated siloxanes include 1,3-divinyl-tetramethyldisiloxane, hexavinyldisiloxane, 1,3-divinyltetraphenyldisiloxane, 1,1,3-trivinyltrimethyldisiloxane, 1,3-dimethytetravinylldisiloxane, and the like. Exemplary cyclic alkyl- or arylvinylsiloxanes include 1,3,5-trivinyl-1,3,5-tri-methylcyclotrisiloxane, 1,3,5,7-tetravinyl-1,3,5,7-tetramethylcyclotetrasiloxane, 1,3-divinyloctaphenylcyclopentasiloxane, and the like.

Suitable polyfunctional hydride siloxanes include compositions depicted below:

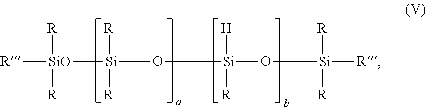

wherein R is as defined previously, R′″ may include R or H, and a and b are defined as above, and selected such that the ratio of b/a allows for at least three reactive Si—H moieties per mole of siloxane of formula (V) above.

Suitable alkyl/hydride cyclosiloxanes are of formula (VI):

[HRSiO]x, (VI)

wherein R is as previously defined, and x is an integer 3 to 18 inclusive.

Other suitable functional hydride siloxanes include:

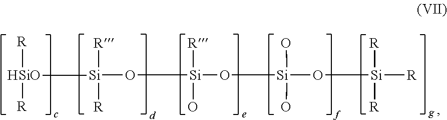

wherein R and R′″ are as previously defined. In some embodiments, the ratio of the sum of (c+d+e+g)/f is >2.

Exemplary siloxane hydrides include poly(methylhydrogen)siloxane, poly[(methylhydrogen)-co-(dimethyl)]siloxane; 1,3,5,7-tetramethylcyclotetrasiloxane, 1,3,5,7,9-pentamethylcyclopentasiloxane, and other cyclic methylhydrogen siloxanes; tetrakis(dimethylsiloxy)silane, and organically modified resinous hydride functional silicates corresponding to Formula (VII), with the composition [HSi(CH₃)₂O_{1/2}]₂ (SiO₂).

The siloxane species in the liquid may be selected so as to include at least one alkenyl and hydride siloxane as described above.

Additional terminally functional alkenyl or hydride siloxanes described below in formulas (VIII) and (IX), alone or in combination, may be added to augment the matrix composition in order to adjust the viscosity of the uncross-linked matrix, effect changes in the cured green body hardness, strength and strain, and so on, as would be apparent to those skilled in the art in view of the present disclosure.

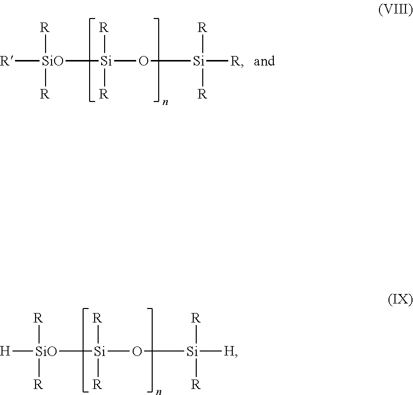

wherein R and R′ are as previously defined; and n=0 to 500, in some embodiments 0 to 30, and in particular embodiments 0 to 10.

It should also be apparent that in some embodiments a satisfactory cross-linked network may be effected by combining one component from each of A) a polyfunctional alkenyl or polyfunctional hydride siloxane, as defined in Formulas (II)-(IV) or Formulas (V)-(VII), respectively; and B) a terminally functional alkenyl or hydride siloxane as defined in Formulas (VIII) or (IX) respectively, restricted only such that the composition contains both an alkenyl and a hydride functional species to allow cross-linking between the complementary alkenyl and hydride reactive functional groups.

The viscosity of the liquid binder, its theoretical cross-link density, and resultant silica char yield may be adjusted using the appropriate siloxane species and the stoichiometric ratio of total hydride to alkenyl reactive functional groups. For instance, the viscosity of the composition can vary from about 1 to about 5000 centistokes, in some embodiments from about 1 to about 300 centistokes, and in particular embodiments from about 1 to about 100 centistokes. The theoretical cross-link density, as represented by the average molecular mass of the shortest formula repeat unit distance between reactive hydride or alkenyl functional cross-link sites (abbreviated for the purposes of this description as MW_{c}), can vary in some embodiments from about 30 to about 4,100 g/mole, in some embodiments from about 30 to about 500 g/mole, and in particular embodiments up to about 150 g/mole. In other embodiments, such as embodiments in which the binder includes a siloxane polymer, the MW_{c} can be much higher, such as, for example, up to about 35,000 g/mole. In some embodiments, the MW_{c} is in the range from about 10,000 g/mole to about 35,000 g/mole. Such comparatively high MW_{c} binders, when processed in accordance with the techniques described herein, may result in a softer, more compliant material with higher strain to failure (in the green to dried state) and with lower cure shrinkage than with lower MW_{c} binders. To produce a suitably hard and resilient cured material, the hydride to alkenyl ratio is generally in the range from about 0.5 to 3, in some embodiments in the range from about 0.5 to 2, and particular embodiments in the range from about 1.0 to 1.75. In the particular case of 1,3,5,7-tetramethylcyclotetrasiloxane and 1,3,5,7-tetravinyl-1,3,5,7-tetramethylcyclotetrasiloxane, combinations in molar ratios from 0.5 to 2 gave silica yields upon pyrolysis of the cured matrix at 1,000° C. in air from 74 to 87% of the original mass.

Generally, the amount of reactive siloxane species included in the ceramic slurry significantly affects the degree of hardness of the resulting solid, shaped product. Using too low an amount may result in unacceptably low strength, while too high an amount may result in material that is difficult to process or lacks sufficiently high ceramic solids content to provide the desired properties. The selection of a desired reactive siloxane species amount (that is, the amount of binder) thus depends on the target application and the nature of the other inputs used in the composition. For example, depending on the amount of other components such as ceramic powder that is present, a useful green product can be formed using greater than about 5 volume percent of the reactive siloxane species, with some embodiments employing from about 20 volume percent to about 40 volume percent of reactive siloxane species as binder liquid relative to the total volume of the composition. In certain embodiments, the one or more reactive siloxane species comprises about 22 to about 37 volume percent of the slurry composition, a range that has been found particularly useful for producing articles for use in investment casting processes, though such applications are not exclusively limited to the use of compositions within this range.

The composition further comprises a catalyst material, such as a metal-containing catalyst. Cross-linking of the siloxane species may be accomplished by utilizing a catalyzed reaction of the alkenyl groups and the silicon-bonded hydrogen groups. Catalysts suitable for such reactions are well known and widely used in the art, including, for example catalysts that include metals such as platinum (Pt), rhodium, iron, palladium, or combinations thereof, usually present in the form of compounds of such metals. Specific examples include, but are not limited to, the Pt divinylsiloxane complexes as described by Karstedt in U.S. Pat. No. 3,715,334 and U.S. Pat. No. 3,775,452; Pt-octyl alcohol reaction products as taught by Lamoreaux in U.S. Pat. No. 3,220,972; the Pt-vinylcyclosiloxane compounds taught by Modic in U.S. Pat. No. 3,516,946; and Ashby's Pt-olefin complexes found in U.S. Pat. Nos. 4,288,345 and 4,421,903. Often, catalyst is added as a final ingredient to a pre-mixed slurry just prior to use of the slurry; even at room temperature there is a certain rate of gelling that may occur as the catalyst promotes cross-linking of the binder liquid. Optionally, inhibitors may be added along with the catalyst to prevent undue premature gelling before a part is cast. Such inhibitors are well known in the art, an example of which is provided in U.S. Pat. No. 4,256,870. Once the slurry mixture is heated, the reaction rate is relatively high whereby polymerization and cross linking of the species is achieved in a practical time span. The amount of metallic catalyst included in the slurry mixture is generally small as compared with the amount of species in accordance with conventional curing and cross-linking methods.

Ceramic powders suitable for use in the present disclosure include, but are not intended to be limited to, oxides, carbides, and/or nitrides; specific examples of such materials include, without limitation, alumina (such as fused alumina), fused silica, magnesia, zirconia, spinels, mullite, glass frits, tungsten carbide, silicon carbide, boron nitride, silicon nitride, and mixtures thereof. In particular embodiments, the ceramic powder includes at least some silica, mixtures of silica and zircon, or mixtures of silica and alumina. The ceramic powder in part provides mechanical integrity for the finished product produced from the slurry composition, and the amount of powder added to the composition contributes to, among other things, the flow properties of the composition and the strength of the green and finished product. In some embodiments, the slurry composition includes at least about 30 volume percent of the ceramic powder, and in particular embodiments, at least about 50 volume percent. In many applications, an excessively high concentration of ceramic powder in the slurry composition may adversely affect the flow properties, rendering the slurry too resistant to flow to allow practical injection or other processing operations. Accordingly, in some embodiments the composition includes up to about 70 volume percent ceramic powder.

The particle size distribution of the ceramic powder may be selected to attain desired rheological properties for the composition, which in turn will depend in part upon the desired application of the composition. Similarly, the powder morphology, including sphericity/angularity, aspect ratio, and the like, may also be optimized for a given application.

Other additives that may be present in the ceramic powder include, but are not intended to be limited to, aluminum, yttrium, hafnium, yttrium aluminate, rare earth aluminates, colloidal silica, magnesium, and/or zirconium for increasing refractory properties of the ceramic body. Alkali and alkaline earth metallic salts are added in some instances to effect devitrification of amorphous silica and promote the formation of cristobalite, leading to a dimensionally stable ceramic body, as desired for precision investment casting. Moreover, various dispersants for ceramic powders are known in the art and are appropriate for use in the present techniques. Care should be exercised, however, to select a dispersant that does not interact with the other components of the slurry composition. A particular dispersant may be evaluated for suitability with a particular combination of material components by mixing small amounts of the respective components and judging the flow properties of the resultant mixture, whether the resultant mixture exhibits a notable yield point, and/or whether the mixture exhibits pseudoplastic behavior. Typical dispersants include stearic acid, oleic acid, and menhaden fish oil. Generally, the dispersant is used in a small amount, by volume, as compared with the amount, by volume, of the ceramic powder included in the mixture.

Further substances may be added to, for instance, modify the ceramic powder surfaces for improved dispersion, for better flow of the slurry, or for enhanced mechanical properties by providing for covalent bonding between an agent absorbed on the surface and a complimentary reactive functionality in the liquid siloxane matrix. These surface-modifying agents may include reactive amino- or alkoxy silanes such as hexamethyldisilazane or methyltrimethoxysilane. Examples of a liquid siloxane matrix-reactive agent may include substances such as 1,3-divinyl tetramethyl disilazane or vinyltriethoxysilane. For purposes of powder surface treatment, enhancement of the above properties may result merely from addition of the agent to the liquid siloxane and powder mixture during processing. Enhancement may also be effected by treatment of the powder surface with the surface-modifying agent in a separate step prior to slurry compounding, either in the liquid phase, in more dilute solution in the presence of a solvent, or in the gas-phase; treatment may be performed and at room temperature or at elevated temperature to speed reactivity and extent of reaction. These and other aspects of surface functionalization are well-known in the art and summarized in monographs on this topic, such as Plueddeman's “Silane Coupling Agents,” Plenum Press, New York (1982).

The composition further comprises a pore-forming agent. A pore-forming agent is a component of the composition (often, but not necessarily always, a liquid component) that does not substantially decompose during processing or substantively participate in the cross-linking reaction that occurs during curing of the binder liquid, and thus can be subsequently removed, such as by evaporating, from the cured material to leave behind a plurality of pores within the cross-linked material matrix. As mentioned above, conventional approaches to ceramic body processing often results in a dense as-cured body that is relatively impermeable to gaseous species entering or exiting the body. Post-cure processes involve pyrolyzing the core—i.e. converting silicone to silica—which involves the formation and/or release of gases. A lack of permeability in the body may lead to structural differences, particularly in features of differing cross-sectional area. These structural differences may manifest themselves as shrinkage differences that may cause cracks to form in the body. Porosity in the as-cured body, created by the inclusion of the pore-forming agent, may enable a more rapid transit of gaseous species, which in turn may reduce the dimensional dependence of shrinkage.

The pore-forming agent includes, and in some cases is made entirely of, a silicon-bearing material such as a silane, a siloxane, or mixtures of such. The pore-forming agent used in embodiments of the present invention, therefore, is advantageously free of current VOC emission-regulated substances such as hydrocarbon-based solvents. The pore-forming agent has a number average molecular weight less than about 1300 grams per mole, and is substantially inert with respect to the liquid binder, meaning that it does not participate in the curing reactions of the liquid binder under typical processing conditions to a degree that would significantly reduce the amount of agent present after curing. The pore-forming agent is also stable in that it undergoes no substantial decomposition or other chemical change while present in the material. On the other hand, the agent has appropriate volatility such that it does not significantly volatilize during handling or other activity prior to or during the curing of the binder liquid, but during normal post-cure processing, which will be discussed further below, the pore-forming agent volatilizes, such as by evaporation, at a rate that is useful for removal of the agent from the cured material. The average molecular weight of the silicon-bearing pore-forming agent is often correlated with its volatility; in certain embodiments, the average molecular weight of the silicon-bearing agent is at least about 150 grams per mole, and in particular embodiments at least about 200 grams per mole. In some embodiments, the average molecular weight of the agent may range from either of these lower values up to about 500 grams per mole.

The amount of pore-forming agent present in the composition is a significant factor in determining the porosity of the “green body”, that is, the material that remains after curing the binder and removing the pore-forming agent. Typically the pore-forming agent is present at a concentration of at least about 5 percent by volume of the entire composition to form sufficient open porosity to enable the transit of gases during processing of the green body. In particular embodiments, a comparatively high degree of porosity in the porous green body, such as at least about 7 volume percent, is desirable to increase the likelihood of forming an interconnected network of pores throughout the green body. On the other hand, depending on the application, porosity in some cases may be desirably controlled so as not to exceed a certain amount to maintain acceptable strength in the green body and/or end product. In some embodiments this upper limit of porosity is about 35 percent by volume, and thus in particular embodiments the pore-forming agent is present in the composition at a concentration in a range from about 7 volume percent to about 35 volume percent of the entire composition. In other embodiments, the upper limit of the pore-forming agent may be dictated by the volume fraction of other components of the composition, such as the ceramic powder. Where a composition has a relatively low loading of ceramic powder, more volume is available for pore-forming agent, and thus, if service conditions for the green product and/or the finished product allow, even higher amounts of pore-forming agent may be feasible.

Examples of silicon-bearing materials suitable for use as, or in, the pore-forming agent include cyclic siloxanes and linear siloxanes. Cyclic siloxane compositions of use as pore-forming agent have a general formula of

[RRSiO]x (X),

where x is an integer from 3 to 18 and each R can be independently any of the R as previously defined, except for groups such as, for instance, alkenyl or hydride groups, that substantially react with the binder liquid. One example of a cyclic siloxane is decamethylcyclopentasiloxane, often referred to in the art as D₅ and commonly available commercially in substantially pure form as, for instance, Momentive SF1202 or Dow-Corning 245 fluids. D₅ has been shown in experiments to possess especially favorable stability and volatility characteristics; this, combined with its general availability, make it a particularly attractive choice for use as the pore-forming agent. Another example is 1,3,5-tris(3,3,3-trifluoropropyl)trimethylcyclotrisiloxane, also known in the art as D₃^{F}. In addition to substantially pure, single components, commercially available mixtures of cyclic siloxanes may also be advantageously employed, for example: Dow-Corning 246, Dow-Corning 344, Dow-Corning 345, Momentive SF1204, Momentive SF1256, Momentive SF1257, and Momentive SF1258 fluids.

Examples of suitable linear siloxanes include without limitation dimethylsiloxanes following the formula R₃SiO(SiR₂O)ₓSiR₃, where R is as defined previously for Formula (X), and x=0-15. Specific examples of suitable linear siloxanes include without limitation hexamethyl disiloxane, octamethyl trisiloxane, decamethyl tetrasiloxane, and dodecamethyl pentasiloxane; commercially available silicone fluids such as Dow-Corning OS-10, OS-20, and OS-30; linear PDMS mixtures such as the Dow-Corning 200 fluids or equivalent Xiameter PMX-200 fluids in the viscosity ranges from 0.65 to 10 cStokes. In some embodiments, use of a siloxane mixture may be advantageous, because the components of the mixture possess a range of vapor pressures and boiling points (as opposed to a pure substance with a single boiling point). This aids in the subsequent removal step by spreading out the temperature range over which the bulk of the fluid volatilization occurs, rather than having all of the fluid in the green body boiling at a single temperature, thereby decreasing the probability of damaging the green body from internal pressures caused by trapped vapor accumulation.

Other examples of silicon-bearing materials include silanes. Examples of suitably non-reactive silanes include, without limitation, phenyltrimethylsilane, tetra-n-butylsilane, p-tolyltrimethylsilane, methyltri-n-trioctylsilane, dimethyldiphenylsilane, and methyltri-n-hexylsilane.

One particular embodiment that applies advantages described above is a composition that includes, at least in part, a liquid (“binder”) comprising a siloxane species as noted previously, the siloxane species comprising an alkenyl functional group and a hydride functional group; a plurality of particles, comprising a ceramic material, disposed within the liquid; a catalyst material comprising a metal, and disposed within the liquid; and a pore-forming agent disposed within the liquid, wherein the pore-forming agent comprises decamethylcyclopentasiloxane and is present in the composition at a concentration in a range from about 5 volume percent to about 35 volume percent of the composition.

As noted previously, the composition described herein may be applied to fabricate a porous ceramic body, such as, for example, a core or a shell for use in investment casting techniques. The composition is disposed in a desired shape, such as by placing the composition into a die that is the shape of a core, or such as by coating the composition over a pattern to create a shell according to practices known in the art; the siloxane species are cured (thereby forming a silicone-based polymeric matrix as noted previously), and the pore-forming agent is volatilized to drive the fluid out of the polymeric matrix, leaving behind a plurality of pores within the matrix and thereby resulting in the formation of a porous green body. The green body may then be heated to produce a ceramic body.

It will be appreciated that in forming articles such as shells, for instance, repeated cycles of coating (such as by dipping a form into a quantity of slurry composition) and curing may be employed to build up a desired shell thickness. Advanced layer-by-layer techniques by so-called “additive manufacturing” methods may also be employed to create complex objects, such as cores and other articles, using the composition, whereby a thin layer of the composition is disposed in a desired shape (such as by injection via a printer nozzle or other deposition equipment), the composition is cured, and then further successive deposition/cure cycles are employed, building up mass layer-by-layer in accordance with a three-dimensional part design, until a part of desired shape is fabricated. In techniques that employ a layer-by-layer approach, the pore-forming agent may be removed at any convenient point in the process, such as (but not limited to) after all layers have been deposited and cured.

If the catalyst is not already present in the slurry composition, it may be added prior to the casting process. The composition is then transferred, e.g., by extrusion, pouring, syringe transfer, pressing, gravity transfer, and the like, into a closed cavity of the mold. Where extrusion is used, the composition is extruded, for example under low pressure (less than 50 psi), into a die and then cured. The curing process is often accomplished with heat for rapid manufacturing. However, room temperature gelation may be desirable where a metal component (if present) reactivity is excessive, e.g. aluminum, wherein the metal component is disposed to react with available organic matter to produce undesirable hydrogen gas bubbles. Other molding techniques, including injection molding, may also be employed. Moreover, any conventional additives known in the ceramic processing arts, for example, mold release agents, may be included in the composition for their known functions.

The temperature at which curing, that is, polymerization and/or cross-linking, is desirably carried out in this method (“curing temperature”) depends in large part on the particular metallic catalyst compound and the particular species that are included. The curing temperature is typically selected to be greater than about room temperature, such as at about room temperature to about 120° C., and in particular embodiments about 50° C. to about 100° C. Similarly, the time necessary to form a firm polymer-solvent gel matrix is dependent on the particular components of the composition. Generally, the mold containing the slurry composition is heated at an elevated temperature (i.e., greater than room temperature) for at least about five minutes, and in some embodiments is heated for a period of about 5 to about 120 minutes, to polymerize and cross-link the siloxane species and form a firm silicone-based polymer matrix.

During the cure step, the pore-forming agent remains present but unreacted, thus persisting to occupy space within the cured matrix. The pore-forming agent is then removed after curing under temperature and pressure conditions suitable to effect volatilization of the agent, and the space formerly occupied by the pore-forming agent becomes desirable porosity within the resultant green body. Removal of the pore-forming agent is typically accomplished by heating to a “drying temperature” at which temperature, for a given pressure, volatilization of the agent is accomplished within a desirable time frame. Ambient processing pressure may remain constant throughout the entire method, or may be adjusted, such as reduced, during the agent removal step to assist in efficient liquid volatilization. In certain embodiments, the drying temperature is greater than the temperature used to cure the composition, to ensure that the agent persists throughout the cure treatment. In some embodiments, the drying temperature is maintained below the boiling point of the pore-forming agent to better control the evolution of vapor during processing, because vapor production that occurs too quickly may cause vapor accumulation in the cured body, increasing risk of damage to the body. A typical range for the drying temperature is up to about 300° C., but of course will in part depend on specific material choices made in formulating any particular instance of the composition.

The composition described herein may provide enhanced dimensional control compared with conventional systems, in part through better dimensional stability during the drying step. Filler particles trapped within the cured resin tend to remain in place, limiting the particle rearrangement commonly observed during drying of conventional systems. As a result, drying shrinkage in embodiments of the present invention may be significantly decreased compared to conventional slurry-cast systems.

The porous green body may be subsequently heated (“fired”) to decompose the silicone-based polymer of the green body, thus forming a ceramic body that includes silica from the decomposed polymer and ceramic material from the powder originally suspended in the slurry composition. Firing may be accomplished by heating at a firing temperature, for example, greater than about 475° C. Moreover, the ceramic body thus formed may be further processed as desired; for instance, the ceramic body may be sintered to form a body of adequate density for use in investment casting. Sintering temperatures for various ceramic powders are well known in the art. In a particular example, the porous green body may be heated in a conventional kiln under an oxygen-containing atmosphere to a temperature of about 900° C. to about 1,650° C. for an aggregate period of about 2 to about 48 hours. The heating rate is typically, but not necessarily, from about 5° C. per hour to about 200° C. per hour.

The resultant ceramic body may be employed in an investment casting process, such as by using the body as a mold core. In such embodiments, the ceramic body has a shape that conforms to a desired shape for an internal cavity in the part to be fabricated by investment casting. For example, the ceramic body may have a shape corresponding to the internal cooling passages of a fluid-cooled machine component, such as an air-cooled turbine blade. In keeping with well-known methods for investment casting, the ceramic body is disposed within an investment casting mold cavity, molten metal is poured or otherwise disposed within the mold cavity (thereby immersing the ceramic body), and then the molten metal is solidified within the mold. The ceramic body (core) is removed by chemical leaching or other method, leaving behind a space within the solidified metal part.

### EXAMPLES

The following examples are presented to further describe the techniques, but should not be read as limiting, because variations still within the scope of embodiments of the present invention will be apparent to those skilled in the art.

### Comparative Example

A ceramic slurry composition with the reactive siloxane binder system and powder mixture corresponding to Example 3 of U.S. Pat. No. 7,287,573 was produced by combining the listed ingredients in the proportions specified in Table 1, below. The reactive siloxanes were 1,3,5,7-tetravinyl 1,3,5,7-tetramethylcyclotetrasiloxane (United Chemical Technologies, product number T2160) and a hydride-functional organosilicate resin (Momentive Performance Materials 88104EX). Na-IRP64, a sodium form of a weak acid ion exchange resin, IRP64 (produced by Rohm & Haas), was additionally included as a mineralizer to enhance the conversion of amorphous silica to cristobalite during sintering.

TABLE 1
Comparative Example Slurry Composition

| Component | Wt % |
|---|---|
| UCT T2160 | 7.53 |
| Momentive 88104EX | 9.90 |
| Na-IRP64 | 0.60 |
| fumed silica | 1.05 |
| zircon | 39.45 |
| fused silica | 41.47 |
| Total | 100.0 |

The above composition represents a ceramic slurry with a ceramic (zircon+silicas) loading of about 62% by volume. The components were mixed in a DAC1100-FVZ HS dual asymmetric centrifuge (Flacktek, Landrum, S.C.), with intermittent hand-mixing, for a total of 3 minutes, 10 seconds mix time at 1600 RPM. After cooling, the slurry was catalyzed by addition of 9.4 microliters of Karstedt's-type platinum catalyst (GE Silicones 89023, 10% Pt by weight) per 100 parts by weight of slurry. The resultant catalyzed slurry was transferred into 6 oz. cartridges, degassed under reduced pressure, then injected into fugitive organic polymeric molds using a manual caulker cartridge gun (Techon Systems). The molds were rectangular-shaped with internal dimensions 4″×0.625×0.2″ (L×W×H). The filled test bar molds were then heated for 15 hours in an air-circulating oven at 50° C. to cure the reactive siloxane binder matrix.

After curing was completed, the cured rectangular test bar specimen/molds were loaded into an electric furnace and fired in an air atmosphere to a terminal temperature of 1000° C. for 3 hrs, with intermediate isothermal holds for 3 hrs. each at 150, 175, 200, 300, 500, and 650° C. Following sintering at 1000° C., the furnace was turned off and the contents allowed to cool naturally back to room temperature. After firing, the room temperature MOR (modulus of rupture) of the resultant sintered ceramic test bars was measured on an Instron 4465 load frame in 4-point bend mode. The open porosity and bulk density of the broken pieces were determined by Archimedean buoyancy measurements in water, according to the methods and definitions set forth in ASTM C830.

### Example 1

Comparable 62 volume % ceramic solids slurry formulations and rectangular test bars were produced and fabricated in the same fashion as described for the Comparative Example, but with decamethyl cyclopentasiloxane (Momentive SF1202, D₅) added to the slurry mixture as a pore-forming agent. Formulations A-D were produced, with 5, 10, 15, and 20% of the total slurry volume, respectively, comprising D₅, with the volume fraction of the reactive siloxane mixture reduced accordingly to maintain a constant 62 volume % ceramic solids loading in the uncured mixture.

As in the Comparative Example, the mass ratio of the reactive siloxanes was maintained to give an approximately 1:1 Si—H to vinyl molar ratio. The prepared slurries were catalyzed with 9.4 uL 89023 Pt catalyst solution per 100 parts by weight slurry mixture, injected into test bar molds, cured, fired, and tested as in the Comparative Example. Mean test values for Formulations A-D are given in Table 2, along with those data for the Comparative Example.

TABLE 2
Test Data for Fired Ceramic Parts Fabricated from Slurry Compositions
Containing from 0-20 Volume % D₅ as Pore-Former

| | Pore-Former | Open | | Bulk | | RT | |
|---|---|---|---|---|---|---|---|
| Sample | Volume % | Porosity | ±95% | Density | ±95% | MOR | ±95% |
| ID | (D₅) | (Vol %) | CI | (g/cm³) | CI | (psi) | CI |
| Compar- | 0 | 13.02 | 0.15 | 2.438 | 0.004 | 1159 | 47 |
| ative | | | | | | | |
| Example | | | | | | | |
| A | 5 | 14.23 | 0.16 | 2.427 | 0.005 | 893 | 154 |
| B | 10 | 17.03 | 0.15 | 2.369 | 0.005 | 2027 | 336 |
| C | 15 | 19.54 | 0.19 | 2.323 | 0.007 | 4107 | 147 |
| D | 20 | 22.53 | 0.17 | 2.247 | 0.004 | 3515 | 68 |

### Example 2

Comparable 62 volume % ceramic solids slurry formulations and rectangular test bars were produced in the same fashion as described for the Comparative Example, but with a linear 5 cStk viscosity PDMS fluid added to the slurry mixture as a pore-forming agent. The 5 cStk PDMS fluid had a number average molecular weight (MW), determined by ²⁹Si-NMR end-group analysis, ranging from 741 to 830 g/mole. Formulations E-H were produced, with 5, 10, 15, and 20% of the total slurry volume, respectively, consisting of pore-forming agent, with the volume fraction of the reactive siloxane mixture reduced accordingly to maintain the targeted 62 volume % ceramic solids loading.

As in the Comparative Example, the mass ratio of the reactive siloxanes was maintained to give an approximately 1:1 Si—H to vinyl molar ratio. The prepared slurries were catalyzed with 9.4 uL 89023 Pt catalyst solution per 100 parts by weight slurry mixture, injected into test bar molds, cured, fired, and tested as in the Comparative Example. Mean test values for Formulations E-H are given in Table 3, along with those data for the Comparative Example.

TABLE 3
Test Data for Fired Ceramic Parts Fabricated from
Slurry Compositions Containing from 0-20 Volume
% of a 5 cStk PDMS Fluid as Pore-Former

| | | Open | | Bulk | | RT | |
|---|---|---|---|---|---|---|---|
| Sample | Pore-Former | Porosity | ±95% | Density | ±95% | MOR | ±95% |
| ID | (Vol %) | (Vol %) | CI | (g/cm³) | CI | (psi) | CI |
| Compar- | 0 | 13.02 | 0.15 | 2.438 | 0.004 | 1159 | 47 |
| ative | | | | | | | |
| Example | | | | | | | |
| E | 5 | 14.31 | 0.39 | 2.423 | 0.011 | 1380 | 141 |
| F | 10 | 17.40 | 0.12 | 2.355 | 0.006 | 1644 | 238 |
| G | 15 | 20.01 | 0.33 | 2.305 | 0.010 | 2720 | 465 |
| H | 20 | 21.24 | 0.38 | 2.279 | 0.013 | 3822 | 53 |

### Example 3

Two 0.77″ (19.6 mm) long cylindrical test specimens of respective average diameter 0.09″ (2.3 mm) and 0.4″ (10.2 mm) were fabricated using a silicone-based slurry corresponding to the composition described for the Comparative Example, above. Two more test specimens of same nominal dimension, respectively, were fabricated using a slurry of composition corresponding to Formulation G, above. After curing, the specimens were heated to 180° C. at 5° C./hr with intermediate soaks under a pressure of 0.1 Torr to remove the pore-forming agent, followed by firing in atmospheric conditions to 480° C. at rates of 5-15° C./hr with at least one intermediate soak. Table 4 summarizes linear shrinkage differential measurements made along the length of the cylindrical specimens (that is, the absolute difference in the shrinkage of the larger specimen from the shrinkage of the smaller specimen), where the shrinkage values reported are based on the summation of the net linear shrinkage attributable to pore-forming agent removal (“drying shrinkage”) and to the firing cycle (“firing shrinkage”).

TABLE 4
Differential Linear Shrinkage Values for Fired Ceramic
Parts Fabricated from Slurry Compositions Containing from
0-15 Volume % of a 5 cStk PDMS Fluid as Pore-Former.

| | Linear shrinkage differential |
|---|---|
| Slurry Formulation | (absolute) |
| Comparative Example (no pore- | 0.81% |
| forming agent) | |
| Formulation G (15 vol. % pore | 0.16% |
| forming agent) | |

The above examples demonstrate that with the incorporation of either D₅ or a low molecular weight PDMS fluid into a ceramic slurry, the open porosity of a fired ceramic article resulting therefrom was increased by as much as 73% relative to the Comparative Example. The open porosity in the fired ceramic body can also be manipulated as required in a predictable manner. With the increase in relative open pore volume, the bulk density of the fired ceramic body correspondingly decreases. In addition, an unexpected benefit is that as the amount of pore-forming agent introduced into the slurry increases, the room temperature MOR increases tremendously, by a factor of 3.3 to 3.5 times the values for the Comparative Example. This behavior contrasts with that well-known in ceramic material science, where the highest strength in a material system may often be found as the material densifies and its bulk density approaches the theoretical value. While not wishing to be bound by any particular theory, substitution of the specific pore-forming agents of the present invention may create a reduction in the micro-crack frequency of the fired ceramic body, through a reduction of effective cross-link density in the green ceramic, caused by dilution of the reactive siloxane matrix with the non-reactive pore-forming siloxane. Moreover, the incorporation of a pore-forming agent into the slurry composition as in Example 4 produced articles with dramatically reduced dimensional-dependent shrinkage, suggesting that the enhanced degree of porosity in the as-cured body, created by the inclusion of the pore-forming agent, may enable more rapid transit of gaseous species, which in turn may reduce the dimensional dependence of shrinkage.

### Example 4

Formulation I was produced in similar fashion to the Comparative Example, demonstrating a non-limiting slurry composition useful for the techniques described herein, where the binder in this instance was RTV 615, a system that includes high MW_{c} siloxane material (e.g., in excess of 10,000 g/mole, and in this specific instance, greater than 30,000 g/mole). D₅ was used as the pore-forming agent, in this instance at about 17% by volume. This composition may be catalyzed by addition of about 3.1 microliters of Lamoreaux-type catalyst (a platinum-containing catalyst) per 100 g of slurry.

TABLE 5
Formulation I:

| Component | Wt % |
|---|---|
| D₅ | 7.6 |
| Momentive RTV615 | 12.1 |
| (part A:part B ratio 10:1 by weight) | |
| Na₂B₄O₇ | 0.4 |
| fumed silica | 1.0 |
| zircon | 38.5 |
| fused silica | 40.4 |
| total | 100.0 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A composition comprising:
a liquid that comprises a siloxane species;
a plurality of particles, comprising a ceramic material, disposed within the liquid;
a catalyst material disposed within the liquid; and
a pore-forming agent disposed within the liquid, wherein the pore-forming agent comprises a silicon-bearing agent that is substantially inert with respect to the liquid, and has a number average molecular weight less than about 1300 grams per mole.

2. The composition of claim 1, wherein the siloxane species of the liquid comprise an alkenyl functional group and a hydride functional group.

3. The composition of claim 1, wherein the pore-forming agent comprises a siloxane, a silane, or a combination including a siloxane and a silane.

4. The composition of claim 1, wherein the silicon-bearing agent comprises a cyclic siloxane.

5. The composition of claim 4, wherein the silicon-bearing agent comprises decamethylcyclopentasiloxane (D₅), 1,3,5-tris(trifluoropropyl)trimethylcyclotrisiloxane (D₃^{F}), or mixtures including either or both of these.

6. The composition of claim 1, wherein the silicon-bearing agent comprises a linear siloxane.

7. The composition of claim 1, wherein the silicon-bearing agent comprises a mixture of silicon-bearing agent components, wherein the components of the mixture have different boiling points.

8. The composition of claim 1, wherein the silicon-bearing agent comprises phenyltrimethylsilane, tetra-n-butylsilane, p-tolyltrimethylsilane, methyltri-n-trioctylsilane, dimethyldiphenylsilane, methyltri-n-hexylsilane, or combinations including one or more of these.

9. The composition of claim 1, wherein the pore-forming agent is present at a concentration of at least about 5 percent by volume of the entire composition.

10. The composition of claim 1, wherein the pore-forming agent is present in the composition at a concentration in a range from about 7 volume percent to about 35 volume percent of the entire composition.

11. The composition of claim 1, wherein the pore-forming agent comprises decamethylcyclopentasiloxane and is present in the composition at a concentration of 7 volume percent to about 35 volume percent of the entire composition.

12. The composition of claim 1 wherein the average molecular weight of the silicon-bearing agent is at least about 150 grams per mole.

13. The composition of claim 1, wherein the ceramic material comprises an oxide.

14. The composition of claim 13, wherein the oxide comprises silica, alumina, zirconia, or mixtures thereof.

15. The composition of claim 1, wherein the pore-forming agent comprises a siloxane and a silane.

16. The composition of claim 1, wherein the catalyst material comprises a metal.

17. The composition of claim 16, wherein the metal comprises platinum, rhodium, iron, palladium, or combinations thereof.

18. A composition, comprising:
a liquid comprising a siloxane species, the siloxane species comprising an alkenyl functional group and a hydride functional group;
a plurality of particles, comprising a ceramic material, disposed within the liquid;
a catalyst material comprising a metal, and disposed within the liquid; and
a pore-forming agent disposed within the liquid, wherein the pore-forming agent comprises decamethylcyclopentasiloxane and is present in the composition at a concentration of 5 volume percent to about 35 volume percent of the entire composition.

19. A method comprising:
disposing the composition of claim 1 into a desired shape;
curing the siloxane species, and
volatilizing the pore-forming agent to form a porous green body.

20. The method of claim 19, further comprising firing the green body to form a ceramic body.

21. The method of claim 19, wherein curing comprises reacting the siloxane species at a curing temperature and wherein volatilizing the pore-forming agent is performed at a drying temperature that is greater than the curing temperature.

22. The method of claim 19, wherein the porous green body has an open porosity level in a range from about 5 volume percent to about 35 volume percent.

23. The method of claim 20, further comprising disposing the ceramic body within an investment casting mold, and solidifying molten metal within the investment casting mold.

24. The method of claim 19, wherein disposing comprises injecting the material via a printer nozzle.

25. The method of claim 24, wherein disposing comprises disposing a plurality of layers of the material in successive deposition actions.
